(19) United States
(12) Patent Application Publication
(10) Pub. No.: US 2013/0322094 A1
(43) Pub. Date: Dec. 5, 2013

(54) LIGHT GUIDE CASING

(71) Applicant: Wei-Hsun Hsu, Taipei (TW)

(72) Inventor: Wei-Hsun Hsu, Taipei (TW)

(73) Assignee: Primax Electronics Ltd., Taipei (TW)

(21) Appl. No.: 13/586,515

(22) Filed: Aug. 15, 2012

(30) Foreign Application Priority Data
Jun. 1, 2012 (TW) 101119727

(51) Int. Cl. F21V 7/00

(52) U.S. Cl. 362/346; 362/341

(57) ABSTRACT

A light guide casing is used for transmitting a light beam from an indicating lamp. The light guide casing includes a light inputting surface, a light outputting surface, and a first reflective surface. The light outputting surface includes a first plane and a second plane. After the light beam from the indicating lamp is transmitted through the light inputting surface, a first portion of the light beam is reflected to the first plane of the light outputting surface by the first reflective surface, and a second portion of the light beam is transmitted to the second plane of the light outputting surface.

### FIELD OF THE INVENTION

The present invention relates to a light guide casing, and more particularly to a light guide casing with two light outputting surfaces.

### BACKGROUND OF THE INVENTION

Conventionally, a light source casing with multiple light outputting surfaces (e.g. an arc-shaped casing or an L-shaped casing) is widely used to increase the emergence angle of a light beam from an indicating lamp. Consequently, the users at different viewpoints can easily view the light beam from the indicating lamp and further realize various messages provided by the indicating lamp.

The conventional light source casing with multiple light outputting surfaces is usually located at a junction between two planes of an electronic device. The electronic device is for example an input device, a communication device, a faxing device, a copying device, a printing device, a scanning device, an automatic document feeder or any other electronic device with an indicating lamp.

FIG. 1 schematically illustrates the relationship between a conventional light source casing and an indicating lamp. As shown in FIG. 1, the conventional light source casing 10 comprises an arc-shaped light inputting surface 11 and an arc-shaped light outputting surface 12. In addition, the indicating lamp L is located at a side of the arc-shaped light inputting surface 11. When the indicating lamp L emits a light beam, the light beam from the indicating lamp L is incident into the arc-shaped light inputting surface 11 and transmitted to the arc-shaped light outputting surface 12.

However, as shown in FIG. 1, the distance between the indicating lamp L and each of both ends A of the arc-shaped light outputting surface 12 is greater than the distance between the indicating lamp L and the middle point B of the arc-shaped light outputting surface 12. In addition, the conventional light source casing 10 has no light guide structure. Consequently, the brightness value at both ends A of the conventional light source casing 10 is usually higher than the brightness value at the middle point B. Under this circumstance, the light beams results in unpleasing visual effect. Moreover, since the light beam is not uniformly distributed, the emergence angle of the light beam from the indicating lamp fails to be effectively increased.

### SUMMARY OF THE INVENTION

The present invention provides a light guide casing for uniformly distributing a light beam.

In accordance with an aspect of the present invention, there is provided a light guide casing for transmitting a light beam from an indicating lamp. The light guide casing includes a light inputting surface, a light outputting surface, and a first reflective surface. The light inputting surface is located at a side of the indicating lamp. The light outputting surface includes a first plane and a second plane, wherein there is a first included angle between the first plane and the second plane. The first reflective surface is located beside the light inputting surface and opposite to the first plane of the light outputting surface, wherein there is a second included angle between the first reflective surface and the light inputting surface. After the light beam from the indicating lamp is transmitted through the light inputting surface, a first portion of the light beam is reflected to the first plane of the light outputting surface by the first reflective surface, and a second portion of the light beam is transmitted to the second plane of the light outputting surface.

In an embodiment, the indicating lamp is a light emitting diode.

In an embodiment, the light guide casing further includes a recess. The recess is disposed within the light guide casing and opposite to the first plane of the light outputting surface, wherein a surface of the recess is served as the first reflective surface.

In an embodiment, the light guide casing further includes a second reflective surface. The second reflective surface is located beside the light inputting surface and opposite to the first reflective surface for reflecting a third portion of the light beam to the second plane of the light outputting surface.

In an embodiment, the first included angle is 90 degrees.

In an embodiment, the second included angle is not smaller than 45 degrees.

In an embodiment, the light guide casing is made of a light-transmissible material.

In an embodiment, the light outputting surface further includes an arc-shaped surface. The arc-shaped surface is arranged between the first plane and the second plane for connecting the first plane and the second plane.

In an embodiment, the light inputting surface is parallel with the second plane of the light outputting surface.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the relationship between a conventional light source casing and an indicating lamp;

FIG. 2 schematically illustrates a light guide casing according to an embodiment of the present invention; and

FIG. 3 schematically illustrates the optical path of the light beam within the light guide casing of the present invention.

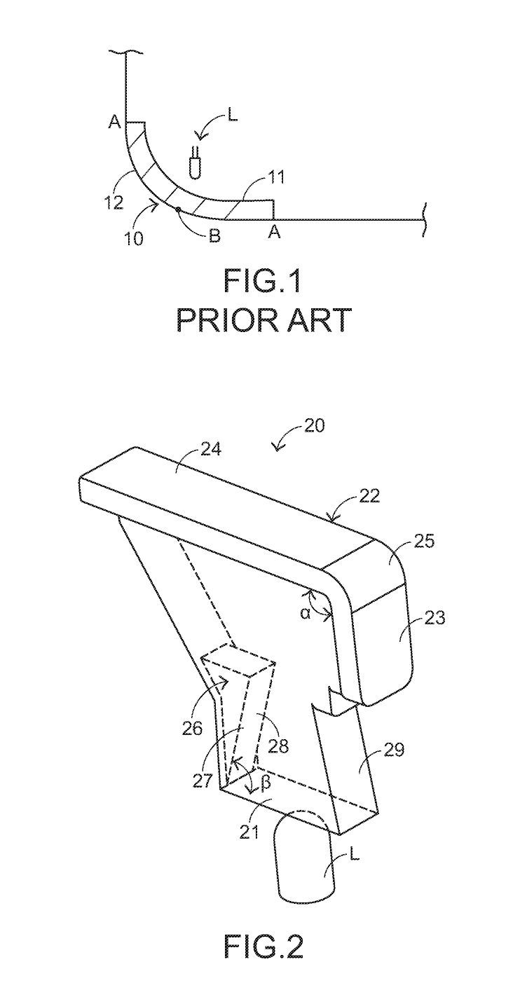

### DETAILED DESCRIPTION OF THE PREFERRED EMBODIMENT

The present invention provides a light guide casing. The light guide casing is located at a junction between two planes of an electronic device. The electronic device includes for example an input device, a communication device, a faxing device, a copying device, a printing device, a scanning device, an automatic document feeder or any other electronic device with an indicating lamp. The light guide casing is used for transmitting the light beam from an indicating lamp.

For reducing the inherent volume of the indicating lamp, an example of the indicating lamp L applied to the light guide casing of the present invention includes but is not limited to a light emitting diode.

FIG. 2 schematically illustrates a light guide casing according to an embodiment of the present invention. As shown in FIG. 2, the light guide casing 20 comprises a light inputting surface 21, a light outputting surface 22, and a first reflective surface 28. The light inputting surface 21 of the light guide casing 20 is located at a side of the indicating lamp L for receiving the light beam from the indicating lamp L.

The light outputting surface 22 comprises a first plane 23 and a second plane 24. There is a first included angle cc between the first plane 23 and the second plane 24. For matching the appearance of the electronic device which is equipped with the light guide casing 20, the first included angle a is preferably set as 90 degrees. In this embodiment, the light inputting surface 21 is parallel with the second plane 24 of the light outputting surface 22. Moreover, the light outputting surface 22 further comprises an arc-shaped surface 25. The arc-shaped surface 25 is arranged between the first plane 23 and the second plane 24 for connecting the first plane 23 and the second plane 24. The arc-shaped surface 25 is presented herein for purpose of illustration and description only.

In accordance with the present invention, the light guide casing 20 has a function of guiding the light beam. Consequently, the light guide casing 20 is made of a transparent light-transmissible material or a translucent light-transmissible material. An example of the transparent light-transmissible material or the translucent light-transmissible material includes but is not limited to polymethylmethacrylate (PMMA), synthetic resin, acrylic resin, polycarbonate (PC), polyethylene terephthalate (PET), polyolefines or glass. In addition, the transparent light-transmissible material or the translucent light-transmissible material may be produced as a block-type body by an injection molding method, an etching method, a hot-press forming method, a cut processing method, or the like.

Please refer to FIG. 2 again. The first reflective surface 28 of the light guide casing 20 is located beside the light inputting surface 21. In addition, the first reflective surface 28 is opposite to the first plane 23 of the light outputting surface 22. By the first reflective surface 28, the light beam from the indicating lamp L may be reflected to the first plane 23 of the light outputting surface 22. In this embodiment, there is a second included angle 13 between the first reflective surface 28 and the light inputting surface 21. In this embodiment, the second included angle β is not smaller than 45 degrees. It is noted that the range of the second included angle β is presented herein for purpose of illustration and description only.

A method of forming the first reflective surface 28 will be illustrated as follows.

Firstly, as shown in FIG. 2, the light guide casing 20 further comprises a recess 26. The recess 26 is disposed within the light guide casing 20. In addition, the recess 26 is opposite to the first plane 23 of the light outputting surface 22. In this embodiment, the recess 26 of the light guide casing 20 is formed during the light guide casing 20 is produced through a mold (not shown). The recess 26 of the light guide casing 20 may be formed by other methods. In some other embodiments, after the light guide casing 20 is produced, the recess 26 is formed by an etching method or a cutting method.

Moreover, the traveling speed of light in the light guide casing 20 is lower than the traveling speed of light in the air of the recess 26, and the second included angle 13 is not smaller than 45 degrees. Consequently, when the light beam from the indicating lamp L strikes the surface 27 of the recess 26 through the light inputting surface 21 of the light guide casing 20, the portion of the light beam having an incidence angle larger than the critical angle is subject to total reflection. In other words, the surface 27 of the recess 26 is the first reflective surface 28 of the light guide casing 20.

Alternatively, in some other embodiments, the surface 27 of the recess 26 is directly coated, pasted or electroplated with a reflective material (e.g. a metallic material). Consequently, the surface 27 of the recess 26 has the function of reflecting the light beam. In other words, the surface 27 of the recess 26 is the first reflective surface 28 of the light guide casing 20. The ways of forming the first reflective surface 28 are presented herein for purpose of illustration and description only.

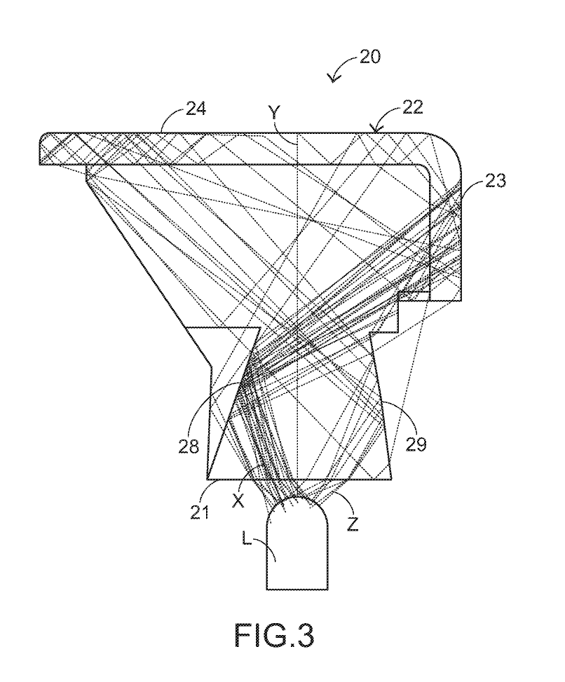

Hereinafter, the optical path of the light beam within the light guide casing 20 will be illustrated with reference to FIG. 3. FIG. 3 schematically illustrates the optical path of the light beam within the light guide casing of the present invention. As shown in FIG. 3, after the light beam from the indicating lamp L is transmitted through the light inputting surface 21 of the light guide casing 20, a first portion X of the light beam is reflected to the first plane 23 of the light outputting surface 22 by the first reflective surface 28. Consequently, the first plane 23 of the light outputting surface 22 is illuminated.

Next, please refer to FIGS. 2 and 3. As shown in FIG. 2, the light guide casing 20 further comprises a second reflective surface 29. The second reflective surface 29 is located beside the light inputting surface 21. In addition, the second reflective surface 29 is opposite to the first reflective surface 28. In this embodiment, the second reflective surface 29 is a sidewall of the light guide casing 20. It is noted that the second reflective surface 29 is not limited to the sidewall of the light guide casing 20.

After the light beam from the indicating lamp L is transmitted through the light inputting surface 21 of the light guide casing 20, as shown in FIG. 3, a second portion Y of the light beam entering the light guide casing 20 and having the smaller incidence angle may result in a smaller refraction angle. Under this circumstance, the second portion Y of the light beam can be directly transmitted to the second plane 24 of the light outputting surface 22 through the light guide casing 20. Consequently, the second plane 24 of the light outputting surface 22 is illuminated.

Moreover, as shown in FIG. 3, a third portion Z of the light beam has a larger incidence angle. The third portion Z of the light beam entering the light guide casing 20 may result in a larger refraction angle. When the third portion Z of the light beam strikes the second reflective surface 29, the third portion Z of the light beam is reflected to the second plane 24 of the light outputting surface 22 by the second reflective surface 29. Consequently, the second plane 24 of the light outputting surface 22 is illuminated.

From the above description, the light guide casing of the present invention comprises a light inputting surface, a light outputting surface, and a first reflective surface. In addition, the light outputting surface comprises a first plane and a second plane. After a light beam from an indicating lamp is transmitted through the light inputting surface, a first portion of the light beam is reflected to the first plane of the light outputting surface by the first reflective surface, and a second portion of the light beam is transmitted to the second plane of the light outputting surface. Due to the first reflective surface, the light beam from the indicating lamp can be uniformly distributed over the first plane and the second plane of the light outputting surface. In such way, the emergence angle of the light beam from the indicating lamp is increased, and thus the users at different viewpoints can easily view the light beams from the indicating lamp.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light guide casing for transmitting a light beam from an indicating lamp, said light guide casing comprising:
a light inputting surface located at a side of said indicating lamp;
a light outputting surface comprising a first plane and a second plane, wherein there is a first included angle between said first plane and said second plane; and
a first reflective surface located beside said light inputting surface and opposite to said first plane of said light outputting surface, wherein there is a second included angle between said first reflective surface and said light inputting surface, wherein after said light beam from said indicating lamp is transmitted through said light inputting surface, a first portion of said light beam is reflected to said first plane of said light outputting surface by said first reflective surface, and a second portion of the light beam is transmitted to said second plane of the light outputting surface.

2. The light guide casing according to claim 1, wherein said indicating lamp is a light emitting diode.

3. The light guide casing according to claim 1, wherein said light guide casing further comprises a recess, wherein said recess is disposed within said light guide casing and opposite to said first plane of said light outputting surface, wherein a surface of said recess is served as said first reflective surface.

4. The light guide casing according to claim 1, wherein said light guide casing further comprises a second reflective surface, wherein said second reflective surface is located beside said light inputting surface and opposite to said first reflective surface for reflecting a third portion of said light beam to said second plane of said light outputting surface.

5. The light guide casing according to claim 1, wherein said first included angle is 90 degrees.

6. The light guide casing according to claim 1, wherein said second included angle is not smaller than 45 degrees.

7. The light guide casing according to claim 1, wherein said light guide casing is made of a light-transmissible material.

8. The light guide casing according to claim 1, wherein said light outputting surface further comprises an arc-shaped surface, wherein said arc-shaped surface is arranged between said first plane and said second plane for connecting said first plane and said second plane.

9. The light guide casing according to claim 1, wherein said light inputting surface is parallel with said second plane of said light outputting surface.
